(19) United States
(12) Patent Application Publication
(10) Pub. No.: US 2004/0062659 A1
(43) Pub. Date: Apr. 1, 2004

(54) Ion pump with combined housing and cathode

(76) Inventor: Mahadeva P. Sinha, Temple City, CA (US)

Correspondence Address: FISH & RICHARDSON, PC, 12390 EL CAMINO REAL, SAN DIEGO, CA, 92130-2081, US

(21) Appl. No.: 10/620,288

(22) Filed: Jul. 14, 2003

Related U.S. Application Data
(60) Provisional application No. 60/395,794, filed on Jul. 12, 2002.

(51) Int. Cl. H01J 7/16

(52) U.S. Cl. 417/50; 313/7

(57) ABSTRACT

An one pump is formed with its housing made of titanium so that the housing can form the cathode of the ion pump. Cylindrical anodes may be formed inside the housing. Spikes or posts may be formed on the walls of the housing and may extend into the inside of the anodes.

### CROSS-REFERENCE TO RELATED APPLICATIONS

This application claims priority to U.S. Provisional Patent Application No. 60/395,794, filed Jul. 12, 2002. The disclosure of which is incorporated herein by reference in its entirety.

### BACKGROUND

It is often necessary to ascertain the composition of various substances. For example, there are many important applications for real-time, on-site measurements of compounds in various environments. These include measurements at toxic waste sites, work places, industrial sites, accidental spill sites, and semiconductor fabrication facilities. A mass spectrometer (MS), either alone or in combination with a gas chromatograph (GC), can be used to make such measurements. The combined GC-MS instrument is most widely used for the analysis of chemical samples.

A Gas Chromatograph (“GC”) separates a sample mixture into different components according to some specified parameters. The process separates the different components in time causing each material to arrive sequentially at the output of the Gas Chromatograph.

These separated materials are fed to a Mass Spectrometer (“MS”). The MS allows the spatially-separated materials to be individually processed by the mass spectrometer; i.e., one material can be processed at a time. The MS analyzes each single material to determine its mass spectrum. The mass spectrum of a compound consists of the intensities of different mass-ions originating from the parent molecules and their fragments. The spectrum is characteristic of the chemical compound and may be used for its identification and quantitative measurement.

GCMS systems have historically been extremely large and unwieldy devices. They need high power for operation and have been extremely high in cost.

A mass spectrometer operates by ionizing a gaseous/vapor sample of material. The ion source is maintained under vacumn at a pressure of about 10⁻⁵ torr or less with a vacumn pump. The sample molecules are bombarded with a beam of electrons during the ionization source. The process results in the production of ions of various masses depending on the chemical nature of the sample molecules. The ions are then separated according to their masses (charge to mass ratios) by the application of electric and/or magnetic fields. Intensities of different mass ions are measured by using a detector system.

GCMS systems have broad uses. However, the high cost of using a GCMS system has often prevented the GCMS from being used in certain operations. This high cost is not only based on the hardware; GCMS systems are very heavy and hence difficult to transport. Reducing the size and hence weight of the device can therefore significantly reduce the cost of transportation.

In addition, many GCMS devices require a relatively high vacumn, for proper operation. The mass and power needs for the vacumn pump for these devices can make the GCMS system even more difficult to use.

Many different kind of pumps, such as Turbomolecular pumps have been proposed. However, many of these pumps require a backup pump in addition to the high vacumn pump. Also, many of these pumps have special kinds of moving parts which may lead to reliability issues.

### SUMMARY

The present system defines a special kind of vacumn pump, for example for use in a MS or a combined GCMS device. The pump as described herein is an ion pump with no moving parts and which requires no backup pump. The ion pump obtains special efficiency by forming the vacumn housing in a way that makes it part of the cathode. In addition, the vacumn housing may be made from the same material as the cathode, for example from titanium.

In addition, the operation of the ion pump may be enhanced by using high energy product and/or high permeability magnetic materials. For example, such materials include hiperco-50 and Nd—B—Fe alloy magnetic material.

Another aspect may use posts of cathode material (titanium) erected on the cathode surface. These posts may protrude inside each of the pumping anode cells. This may be used to form a lightweight miniature high performance ion pump.

### DETAILED DESCRIPTION

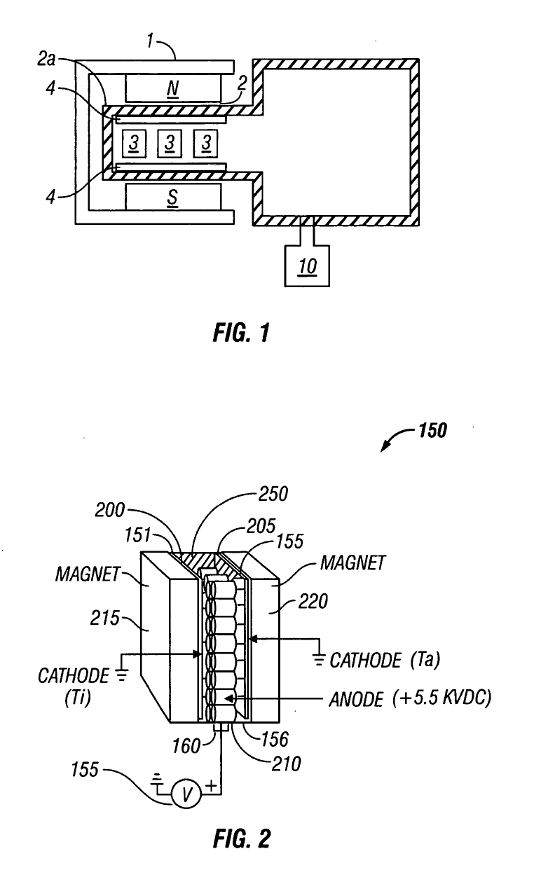

FIG. 1 shows an example of a conventional ion pump. A magnet is formed outside of a stainless steel pump casing 2. A portion of the pump casing 2 extends into the magnetic field generated by the magnet. The part 2a contains a stainless steel anode 3 and a titanium cathode 4.

Stable pumping of inert gases is carried out by forming one side of the cathode out of tantalum. An action on the tantalum produces energetic neutral atoms that pump the inert gases on the anode structure and at the peripheral areas of the cathodes, that is between the anode rings.

As a result of Penning discharge, titanium atoms are sputtered and stick to the internal surface of the pump casing 2. The active titanium atoms adsorb gas molecules in the pump casing 2.

With the gas in the pump casing 2 thus eliminated or evacuated, a given vessel 10 communicating with the pump casing 2 is also evacuated to establish a high degree of vacumn therein.

FIG. 2 shows an ion pump is in a “noble diode” or differential configuration. The configuration includes a first cathode 200 formed of titanium. A second cathode 205 is formed of tantalum. The walls of the housing are electrically connected to both cathodes. The housing is made separately and usually formed of stainless steel.

Anodes 210 are formed between the cathodes. The anodes may be formed of an array of stainless steel cylinders which are positioned between the cathodes, each of the cylinders having axes which extend between the cathode 200 and the cathode 205. The vacumn housing is formed surrounding the anode and cathode, by top and bottom walls 155, 156, and inner walls 151, inside the anode and cathode.

Magnets 215 and 220 are formed outside the vacumn housing, with the first magnet near the cathode part 200, and a second magnet 220 near the cathode part 205. A voltage source 155 is connected between the anode array assembly and ground, through an insulated and vacumn proof connector 160 that extends to the vacumn source.

The inventor found that this configuration may limit the available surface area of the cathode.

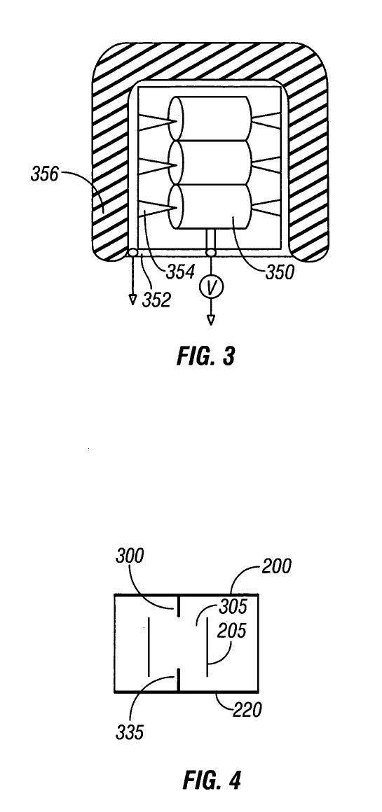

In this invention, the inventor recognized that the housing can actually be used as a cathode. A diagram of this embodiment is shown in FIG. 3 which shows effectively a cross-section of the embodiment. Anodes 350 are cylindrical anodes that are held within the housing. A housing 352 is formed of titanium and forms the cathode that surrounds the anodes 350. The interior surface of the housing includes inwardly-extending spikes 354 which extend into the inside of the anodes.

The magnetic yoke 356 surrounds the anode and cathode assembly.

In operation, the pressure inside the enclosure 352 is reduced to 1-10 microns. A voltage of 3-5 KV DC is applied between the anodes and the grounded housing which acts as the cathode.

The entire surface area of the enclosure can accordingly be used as a cathode and maintained at ground potential. This allows a larger surface area, to pump active gases, and also may reduce the mass of the pump by allowing the metal forming the vacumn chamber to be used as double duty—both a vacumn chamber and also as the cathode. Since the entire vacumn enclosure forms part of the cathode, the cathode surface area can be increased without adding extra structure or weight. The applied voltage causes electrons generated by the ionization to be accelerated towards the anodes.

The anodes are held within and coaxial with the axial magnetic field. The electrons in this region then collide with the gas molecules and generate positive ions. These ions are then accelerated into the cathode. The ions collide with the titanium forming the cathode material, and form neutral atoms which deposit on the anode surfaces.

Because of the chemical activity of titanium, these atoms combine with chemically active gas molecules such as N₂, O₂ and the like, and remove those gas molecules. New layers of titanium are continually deposited. In this way, the active gases are pumped by the operation. Inert gases are buried several atomic layers deep into the cathode as part of the pumping.

In an embodiment, the magnets forming the anode element are formed in a C-shaped configuration and fabricated from rare earth magnet materials such as, Nd—B—Fe and/or Sm—Co, possessing high energy product values. The yoke is fabricated from a high permeability material (hiperco-50A). By doing this, the mass of the magnet can be reduced, which hence can reduce the mass of the pump.

A detailed view of the special shape of the cathode is detailed in FIG. 4. Posts of cathode material may be mounted on the inner surface of the housing cathode itself. These posts protrude into the inside of the anode elements. FIG. 4 shows how the cathode 200 has posts 300 that protrude into the interior portion 305 of each cylindrical anode part 205. Similarly, the other cathode 220 may have similar posts shown as 335.

In operation, materials which are sputtered from the posts may condense on the surface of the anode assembly 205, and also on the cathode plane, at higher rates then in the normal system due to enhanced sputtering at grazing angles that are found from geometrical considerations. This increases the pumping by burial. A post design in the ion pump may produce enhance pumping rates for both active and inert gases.

In an embodiment, a device may have the following general characteristics. The pump may have outer dimensions around 3×3×1 inch. The anode may be formed of 20 cylindrical units. A total mass including the magnet is around 600 g. Using this system, pumping speed for nitrogen of about 7 liters per second has been measured.

Although only a few embodiments have been disclosed in detail above, other modifications are possible. All such modifications are intended to be encompassed within the following claims.

What is claimed is:

1. An ion pump comprising:
a combined housing and cathode structure, formed of a cathode material, and forming a vacumn tight seal and having a vessel connected to said housing;
an anode, formed within said housing; and
a magnet, surrounding at least a portion of said housing, and
a connection for a voltage source of a type that allows pumping.

2. A pump as in claim 1, wherein said housing and cathode structure is formed of titanium.

3. A pump as in claim 1, wherein said magnet is formed in a substantially C shape.

4. A pump as in claim 3, wherein said magnet is formed of one of hiperco-50 magnetic material.

5. A pump as in claim 1, wherein said housing and cathode structure includes a plurality of substantially extending posts, which extend towards said anode.

6. A pump as in claim 1, wherein said anode is formed of a plurality of cylindrical elements, having openings therein.

7. A pump as in claim 6, wherein said housing and cathode structure includes a plurality of extending posts, which extended in a similar direction to an axis of said cylindrical elements.

8. A pump as in claim 7, wherein said posts extend into said opening in each of said plurality of cylindrical elements.

9. A pump as in claim 1, further comprising
a voltage source, which applies a voltage potential between said anode and said housing.

10. An ion pump, comprising:
a vacumn tight housing formed of titanium, defining a chamber therein;
an anode, formed within the chamber, and having an electrical connection which extends to an outside of the chamber, said anode formed of at least one cylinder extending along a specified direction;
said housing having an inner surface with at least first and second extending posts of titanium, which extend into an inside of said at least one cylinder; and
a magnet, surrounding at least a portion of said housing and forming a magnetic field within said housing.

11. An ion pump as in claim 10, wherein said magnetic field extends along a direction that is coaxial with said axis of said anode.

12. An ion pump as in claim 10, further comprising a GCMS a system receiving its vacumn from said ion pump.

13. An ion pump as in claim 10, wherein said magnet is formed of a high energy product value magnet.

14. A method, comprising:
forming an ion pump using a vacumn housing which acts as the cathode of said ion pump.

15. A method as in claim 14, further comprising using a plurality of anodes within said vacumn housing along with said cathode.

16. A method as in claim 15, further comprising providing a magnetic field in said vacumn housing.

17. A method as in claim 16, further comprising applying a potential difference between said vacumn housing and said anodes to cause ion pumping.

18. A method as in claim 17, wherein said anodes are substantially cylindrical, and further comprising a post surface on an inside surface of said vacumn housing which extends into an inside of said anode.

19. An ion pump, comprising:
a vacuum tight a housing formed of titanium, defining a chamber therein, and defining a plurality of posts each extending in a specified axial direction;
a plurality of anodes formed of the conductive material, each of said plurality of anodes being hollow and having axes which expand in said axial direction, and each of said plurality of anodes formed such that at least one of said plurality of posts extends into an inside portion of the hollow anode; and
a vacuum tight connector, enabling application of low voltage between said anodes and said housing, to cause ion pumping therebetween.

20. An ion pump as in claim 19, further comprising a magnet, surrounding at least a portion of said housing.
